(19) United States
(12) Patent Application Publication
(10) Pub. No.: US 2009/0056625 A1
(43) Pub. Date: Mar. 5, 2009

(54) SHIELDING MEMBER OF PROCESSING SYSTEM

(75) Inventors: Chee-Mong Loo, Singapore (SG); Yao-Hung Liu, Tainan County (TW)

Correspondence Address: J C PATENTS, INC., 4 VENTURE, SUITE 250, IRVINE, CA, 92618, US

(73) Assignee: UNITED MICROELECTRONICS CORP., Hsinchu (TW)

(21) Appl. No.: 11/846,710

(22) Filed: Aug. 29, 2007

(51) Int. Cl. B05C 11/11

(52) U.S. Cl. 118/504; 427/458

(57) ABSTRACT

A shielding member applicable in a deposition apparatus is provided. The shielding member includes a base metal and an adhesion promoter layer arc-sprayed on the base metal, wherein adhesion promoter layer has a thickness gradient increasing from an upper end of the shielding member to a lower end of the shielding member. More preferably, no adhesion promoter layer is formed in the upper 10 cm of the shielding member, adjacent to a target layer.

### BACKGROUND OF THE INVENTION

1. Field of Invention

The present invention relates to a shielding member of a processing system; more specifically, the present invention is related to an inner shield applicable in a sputtering chamber of a physical vapor deposition (PVD) processing system and a method of forming the shield.

2. Description of Related Art

Physical vapor deposition, also known as sputtering, is the most established method of depositing metal layers in the fabrication of semiconductor devices. A sputter reactor chamber is typically arranged with a target being supported on the vacuum sealed chamber and a heater supporting a wafer to be sputtered in a position opposite to that of the target. The target is composed of metal or metal compound to be sputtered, for example, tantalum or nickel-platinum. The sputter reactor chamber normally includes a shielding member, for example, an inner shield, to prevent the sputter material from coating. Instead, the sputter material coats the shielding member, which can be removed and cleaned or replaced to obviate the sputter material being accumulated on the inside surface of the chamber to a considerable thickness and flaked off to contaminate the growing film.

The shielding member is typically formed with a metal sheet. The entire surface of the base metal, from top to bottom, is coated with a layer of coating material. The layer of the coating material is, for example, an aluminum oxide material (Al₂O₃), formed by an arc spraying method. The surface of the arc-sprayed coating layer is very rough to provide enhanced mechanical adhesion for the sputter material deposited thereover.

However, it has been observed that after several deposition cycles, the coating material at the top region of the shielding member near the target tends to peel off or shed from the surface of the base metal. One major reason contributed to the peeling of the coating material at the top region of the shielding member near the target is possibly due to its closed proximity to the high temperature target layer where plasma is generated. Once particles are generated in the chamber due to the peeling of the coating material, they may become incorporated into the growing film to contaminate the film.

Further, arching during PVD deposition causes substantial damages to the target and contaminations on the growing film. Arcing is related to the space between the target layer and the shielding member, and is caused by the charge buildup on the target surface that contains the non-conducting contaminants. With a coating material having a substantial thickness formed on base metal, the spacing between the target and the shielding member is reduced to increase the occurrence of arcing.

As a result of the above-mentioned problems, defects are often produced, shield performance is hampered, chamber maintenance and shield replacement are increased and yields are reduced.

### SUMMARY OF THE INVENTION

The present invention is to provide a shielding member for a processing apparatus and a method for fabricating the same, wherein the issues of a coating material of the shielding member being peeled off and contaminating the growing film can be obviated.

The present invention is to provide a shielding member for a processing apparatus and a method for fabricating the same, wherein the occurrence of arcing can be mitigated.

In accordance to an embodiment of the present invention, the shielding member includes an inner shield applicable in a physical vapor deposition apparatus, for example, for depositing atom or ions of a material emitted from a target of the material on a surface of a substrate. The shielding member of the invention includes a metal serving as a base and an adhesion promoter layer comprising metal oxide disposed on the surface of the base metal. The adhesion promoter layer is formed by an arc-spraying method, for example. Further, the adhesion promoter layer has a thickness gradient, increasing from a first end of the shielding member to a second end of the shielding member.

According to an embodiment of the invention, the thickness of the shielding member increases from about 0 μm at the tip of the first end of the shielding member to about 50 μm to 800 μm at the second end of the shielding member.

According to an embodiment of the invention, no adhesion promoter layer is disposed within the plasma zone of the shielding member, which is a region of the shielding member configured substantially near the target.

According to an embodiment of the invention, no adhesion promoter layer is formed within a distance of about 10 cm form a tip of the first end of the shielding member; more preferably, no adhesion promoter layer is formed within a distance of about 6 cm from the tip of the first end of the shielding member. The adhesion promoter layer formed on a remaining surface of the base metal of the shielding member outside the plasma zone has a thickness of about 50 to 800 μm.

According to an embodiment of the invention, the adhesion promoter layer formed on a remaining surface of the base metal of the shielding member outside the plasma zone has a thickness of about 400 μm.

According to an embodiment of the invention, the adhesion promoter layer disposed on a remaining surface of the base metal of the shielding member outside the plasma zone has a substantially constant thickness or a gradient thickness.

According to an embodiment of the invention, a material that constitutes the adhesion promoter layer includes certain oxide materials such as Al₂O₃, Y₂O₃, Zr₂O₃ or certain nitride materials, such as aluminum nitride.

According to an embodiment of the invention, the first end of the shielding member is configured near the target, while the second end of the shielding member is configured near a wafer layer.

Since the thickness of the adhesion promoter layer of the present invention is reduced at a region of the shielding member in close proximity to the target, the problem of peeling of the adhesion promoter layer from the base metal is mitigated. Further, by reducing the thickness of the adhesion promoter layer in the region of the shielding member in close proximity to the target layer, the spacing between the target layer and the shielding member is increased to reduce the chances of arcing.

Hence, in accordance of the present invention, not only the performance of the shielding member is optimized to increase the processing time and to reduce shield replacement, defects due to arcing or shedding of the adhesion promoter layer can be obviated to improve the yields.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a perspective view diagram of a shielding member fabricated according to one embodiment of the invention, the shielding member including a base metal, over which an adhesion promoter layer is deposited.

FIG. 2 is a schematic, cross-section diagram of a processing apparatus for depositing a layer material on a surface of a substrate, the processing apparatus including a shielding member fabricated according to one embodiment of the invention.

### DESCRIPTION OF EMBODIMENTS

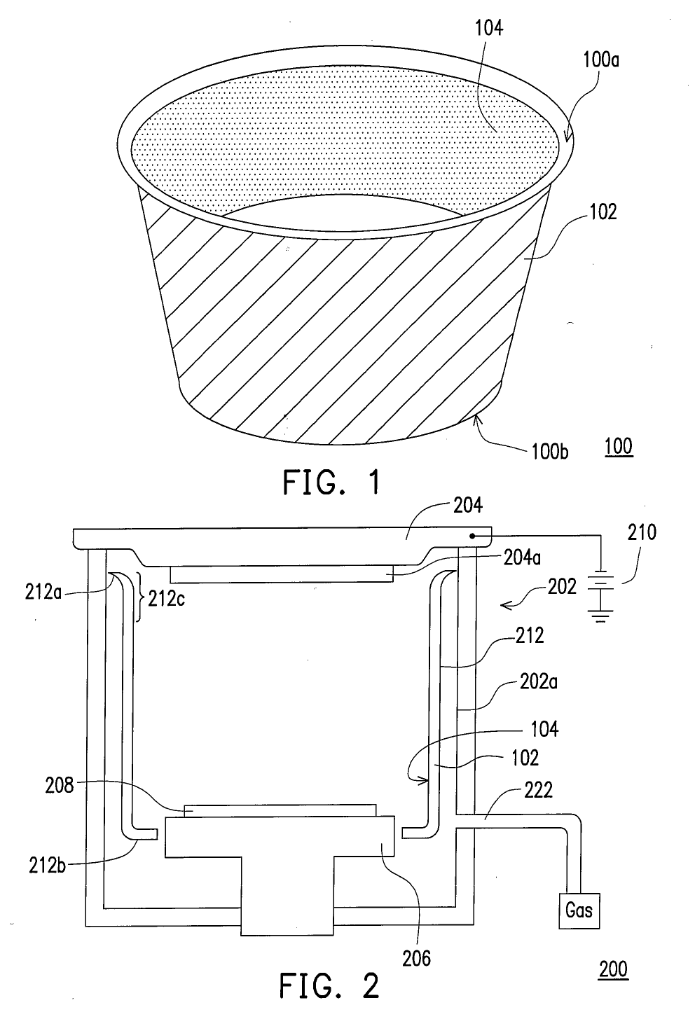

Reference will now be made in detail to the embodiments of the invention, examples of which are illustrated in the accompanying drawings. Whenever possible, the same reference numbers are used in the both FIG. 1 and FIG. 2 of the drawings and the description to refer to the same or like parts.

Referring to FIG. 1, wherein FIG. 1 is a diagram of a shielding member fabricated according to one embodiment of the invention. The shielding member 100 of the invention is, for example, an inner shield formed to cover the inner surface of a processing apparatus, such as a physical vapor deposition chamber. The shielding member 100 is, for example, an annular plate that may or may not include a bottom plate. The shielding member 100 includes two distinct ends: a first end 100a and a second end 100b. In the case that the shielding member 100 is applied as an inner shield in a physical vapor deposition apparatus, the first end 100a is positioned substantially adjacent to a target layer, while the second end 100b is positioned substantially adjacent to a wafer. The shielding member 100 or the inner shield of the invention includes a base metal 102, made from an aluminum sheet with 99.5% minimum purity or stainless steel. On the surface of the base metal 102, an adhesion promoter layer 104 is formed thereon. The adhesion promoter layer 104 includes but not limited to certain oxide materials, such as Al₂O₃, Y₂O₃, Zr₂O₃, etc., or certain nitride materials, such as aluminum nitride. The adhesion promoter layer 104 is formed on the surface of the base metal 102, for example, by a thermal arc spraying method to provide a surface texture having enhanced mechanical adhesion for layers deposited thereover. The arc-spraying temperature is greater than 1000 degrees Celsius, for example.

Further, the adhesion promoter layer 104 disposed on the base metal 102 has a thickness gradient varying from the first end 100a of the shielding member 100 to the second end 100b of the shielding member 100. For example, the adhesion promoter layer 104 may gradually increase from 0 μm thick to about 50 μm to 800 μm thick, for example, from the tip of the first end 100a of the shielding member 100 to the second end 100b. In another embodiment of the invention, no adhesion promoter layer 104 is formed within a distance of about 0 to 10 cm from the tip of the first end 100a of the shielding member, more preferably, within a distance of about 0 to 6 cm from the tip of the first end 100a of the shielding member 100. Further, the remaining surface of the base metal of the shielding member 100 is deposited with the adhesion promoter layer 104 of about 50 to 800 μm thick, for example. Further, the adhesion promoter layer 104 on the remaining surface of the base metal 100 of the shielding member may have a thickness gradient or a substantially constant thickness. In one other embodiment of the invention, the remaining surface of the base metal 102 is deposited with the adhesion promoter layer 104 of about 400 μm thick, for example.

Various experiments have been conducted on a shielding member fabricated according to the invention. The shielding member in the various experiments includes a base metal, wherein the top 60 mm of the base metal is formed with an adhesion promoter layer of different thicknesses. As the results shown in Table 1, the shielding members with no adhesion promoter layer being formed on the top 60 mm of the base metal do not experience the problem of shedding or peeling of the adhesion promoter layer.

TABLE 1

| Arc Spray Coating Specification | Pass | Fail |
|---|---|---|
| Top 60 mm with no coating | 3 | 0 |
| Top 60 mm coating with thickness of 30 μm | 11 | 2 |
| Top 60 mm coating with thickness of 50 μm | 9 | 4 |
| Top 60 mm coating with thickness of 70 μm | 20 | 2 |
| Top 60 mm coating with thickness of 150 μm | 17 | 3 |
| Top 60 mm coating with thickness of 400 μm | | 19 |

The aforementioned shielding member is applicable as an inner shield of a processing apparatus. FIG. 2 illustrates a processing apparatus, for example, a physical vapor deposition (PVD) or a sputtering reactor for forming a layer of material, for example, a metal layer or metal compound layer or other related materials, on a surface of a wafer. The processing apparatus presented in FIG. 2 includes a shielding member fabricated according to one embodiment of the invention.

As shown in FIG. 2, the processing apparatus 200 includes a vacuum chamber 202, which may be cylindrical or tubular in shape, and is usually made of metal and electrically grounded. A target plate 204, which faces downwardly from the top of the chamber 202, is supported on and vacuumed sealed the chamber 202. The target plate 204 includes a target layer 204a, which is a source for providing the material to be sputtered on a wafer. The target layer 204a is composed of metal, for example, tantalum or other refractory metal. A pedestal electrode 206 for supporting a wafer 208 is configured at the lower part of the chamber 202, upwardly facing the target layer 204a. The processing apparatus 200 may further include ports 222 for introducing processing gas, for example, an argon gas, into the chamber 202. During a deposition process, the target layer 204a is negatively biased by a power supply 210 with respect to the grounded metal chamber 202 to discharge the processing gas into plasma and to sputter the metal atoms or ions from the target and to form a metal layer on the wafer 208 surface.

A shielding member, for example, an inner shield 212 is configured inside the chamber 202 to protect the chamber wall 202a from being coated by the sputter material. The inner shield 212 is, for example, an annular plate formed substantially conformal to the circumferential surface of the vacuum chamber, extending from the upper end of the chamber 202 adjacent to the target plate 204 to a lower end of the chamber 202 adjacent to the pedestal electrode 206, for example.

The shielding member 212 is fabricated with a base metal 102, as shown in FIG. 1, which made from an aluminum sheet with 99.5% minimum purity or stainless steel, for example. On the surface of the base metal 102, an adhesion promoter layer 104 is formed thereon. The adhesion promoter layer 104 includes but not limited to certain oxide materials, such as Al₂O₃, Y₂O₃, Zr₂O₃, etc., or certain nitride materials, such as aluminum nitride. The adhesion promoter layer 104 is arc sprayed, for example, on the surface of the base metal 102. In the present invention, the thickness of the adhesion promoter layer 104 is gradient from a first end 212a of the inner shield 212 adjacent to the target layer 204a to a second end 212b of the inner shield 212 adjacent to the pedestal electrode 206. For example, the thickness of the adhesion promoter layer 104 may gradually increase from 0 μm to about 50 μm to 800 μm from the tip of the first end 212a of the inner shield 212 to the second end 212b of the inner shield 212. In another embodiment, no adhesion promoter layer 104 is formed in the plasma zone 212c of the inner shield 212; while the surface of the inner shield 212 outside the plasma zone 212c is formed with the adhesion promoter layer 104 having a constant thickness or a gradient thickness. The plasma zone 212c is a region of the shielding member 212 substantially adjacent to the target layer 204a. For example, the plasma zone 212c is the upper 10 cm of the inner shield 212. In another aspect of the invention, the plasma zone 212c is the upper 6 cm of the inner shield 212. In other words, no adhesion promoter layer 104 is formed within a distance of about 0 cm to about 10 cm, or preferably about 0 cm to about 6 cm, from the tip of the first end 212a of the inner shield 212. In one embodiment of the invention, the thickness of the adhesion promoter layer 104 outside the plasma zone 212c is within the range of about 50 μm to about 800 μm. In another embodiment, the thickness of the adhesion promoter layer 104 outside the plasma zone 212c is about 400 μm. In yet another embodiment, the adhesion promoter layer 104 gradually increases in thickness within the plasma zone 212c from the tip of the first end 212a of the shielding member 212, and maintains a substantially constant thickness, for example, about 50 μm to 800 μm thick, on the remaining surface of the shielding member 212 beyond the plasma zone 212c.

Due to its close proximity to the target layer 204a, the adhesion promoter layer 104 at the plasma zone 212c tends to peel off or shed from the base metal 102, creating particles that may become incorporated into the growing film. One reason that may be responsible for the shedding phenomenon is due to the differential thermal expansion between the adhesion promoter layer 104 and the underlying base metal 102, which is especially prevalent at the site near the high temperature target layer 204a. Since, according to the present invention, the thickness of the adhesion promoter layer 104 at the plasma zone 212c is reduced, the problem of shedding or peeling of the adhesion promoter layer 104 from the base metal 102 is greatly mitigated. Further, arcing is related to the spacing between the target layer 204a and the inner shield 212, which can be exasperated by the thickness of the adhesion promoter layer 104 being coated on the inner shield 212. Hence, by reducing the thickness of the adhesion promoter layer 104 in the plasma zone 212c, the spacing between the target layer 204a and the inner shield 212 is expanded to minimize the occurrence of arcing.

Moreover, the shielding member of the present invention can be easily maintained to extend the number of processing cycles between replacements. The shielding member may be cleaned by an immersion of the shielding member in an upright position into a cleaning solution, for example, a potassium hydroxide (KOH) solution, exposing the plasma zone of the shielding member, followed by dipping the plasma zone segment of the shielding member quickly into the cleaning solution.

Hence, in accordance to the present invention, not only the performance of the shielding member is optimized resulting in longer processing time and fewer shield replacement, defects due to arcing or peeling of the adhesion promoter layer can be obviated to improve the yields.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A method of fabricating a shielding member of a processing system for depositing atoms or ions of a material emitted from a target of the material on a surface of a substrate, wherein the shielding member comprises a first end and a second end, the method comprising:
providing a metal sheet as a base of the shielding member;
on the metal sheet, arc spraying an adhesion promoter layer having a thickness gradient varying from the first end to the second end of the shielding member.

2. The method of claim 1, wherein a thickness of the adhesion promoter layer increases from about 0 μm at a tip of the first end to about 50 μm to 800 μm at the second end of the shielding member.

3. The method of claim 1, wherein no adhesion promoter layer is formed within a plasma zone, which is a region of the shielding member configured substantially near the target.

4. The method of claim 3, wherein the plasma zone extends form a tip of the first end to about 10 cm from the tip of the first end of the shielding member.

5. The method of claim 3, wherein the plasma zone extends form a tip of the first end to about 6 cm from the tip of the first end of the shielding member.

6. The method of claim 3, wherein the adhesion promoter layer formed on the metal sheet of the shielding member outside the plasma zone is about 50 μm to 800 μm thick.

7. The method of claim 3, wherein the adhesion promoter layer formed on the metal sheet of the shielding member outside the plasma zone is about 400 μm thick.

8. The method of claim 1, wherein the adhesion promoter layer is fabricated with a material comprising Al₂O₃, Y₂O₃, Zr₂O₃ or aluminum nitride.

9. The method of claim 1, wherein the shielding member is an inner shield of a deposition apparatus.

10. A shielding member of a processing system for depositing atoms or ions of a material emitted from a target of the material on a surface of a substrate, wherein the shielding member comprises a first end and a second end, the shielding member comprising:
a metal serving as a base of the shielding member;
an adhesion promoter layer arc-sprayed on the metal, wherein the adhesion promoter layer has a thickness gradient varying from the first end to the second end of the shielding member.

11. The shielding member of claim 10, wherein a thickness of the shielding member increases from about 0 μm thick at a tip of the first end to about 50 μm to 800 μm thick at the second end of the shielding member.

12. The shielding member of claim 10, wherein no adhesion promoter layer is disposed within a plasma zone, which is a region of the shielding member configured substantially near the target.

13. The shielding member of claim 10, wherein the plasma zone extends from a tip of the first end to about 10 cm from the tip of the first end of the shielding member.

14. The shielding member of claim 10, wherein the plasma zone extends from a tip of the first end to about 6 cm from the tip of the first end of the shielding member.

15. The shielding member of claim 12, wherein the adhesion promoter layer disposed on the metal of the shielding member outside the plasma zone is about 50 μm to 800 μm thick.

16. The shielding member of claim 12, wherein the adhesion promoter layer disposed on the metal of the shielding member outside the plasma zone is about 400 μm thick.

17. The shielding member of claim 12, wherein the adhesion promoter layer disposed outside the plasma zone has a constant thickness.

18. The shielding member of claim 12, wherein the adhesion promoter layer disposed outside the plasma zone has a gradient thickness.

19. The shielding member of claim 10, wherein a material constituting the adhesion promoter layer comprises Al₂O₃, Y₂O₃, Zr₂O₃ or aluminum nitride.

20. The shielding member of claim 10, wherein the shielding member is an inner shield of a physical vapor deposition apparatus.

21. The shielding member of claim 10, wherein the metal is constituted with a material comprising aluminum with 99.5% minimum purity.
